(19) United States
(12) Patent Application Publication
(10) Pub. No.: US 2016/0216170 A1
(43) Pub. Date: Jul. 28, 2016

(54) OCCUPANT SENSING DEVICE

(71) Applicant: Aisin Seiki Kabushiki Kaisha, Kariya-shi (JP)

(72) Inventor: Ryota NAKANISHI, Obu-shi (JP)

(73) Assignee: Aisin Seiki Kabushiki Kaisha, Kariya-shi (JP)

(21) Appl. No.: 15/003,903

(22) Filed: Jan. 22, 2016

(30) Foreign Application Priority Data
Jan. 27, 2015 (JP) 2015-013589

(51) Int. Cl. G01L 25/00; B60N 2/00; G01L 5/00

(52) U.S. Cl. CPC G01L 25/00; G01L 5/00; B60N 2/002

(57) ABSTRACT

An occupant sensing device includes: an adjustment value holding portion which holds an adjustment value of a seat load detected by a load sensor; an occupant sensing portion which senses a sitting state of an occupant in a seat provided with the load sensor based on the seat load after adjustment by the adjustment value held by the adjustment value holding portion; an identification information holding portion which holds identification information which is essential for a normal load sensor as held identification information; an identification information obtaining portion which obtains the identification information which is essential for the load sensor provided in the seat as target identification information; and a collation judgment portion which collates the held identification information held by the identification information holding portion and the target identification information obtained by the identification information obtaining portion.

### CROSS REFERENCE TO RELATED APPLICATIONS

This application is based on and claims priority under 35 U.S.C. §119 to Japanese Patent Application 2015-013589, filed on Jan. 27, 2015, the entire contents of which are incorporated herein by reference.

### TECHNICAL FIELD

This disclosure relates to an occupant sensing device.

### BACKGROUND DISCUSSION

In general, a load sensor is provided below a vehicle sheet. In addition, a configuration in which safety measures, such as prompting an occupant sitting in the vehicle seat to wear a seat belt, or changing expansion control of an airbag in accordance with the occupant, are performed by sensing a sitting state of the occupant based on a seat load detected by the load sensor, is adopted.

In addition, in such an occupant sensing device, there is a device which holds an adjustment value of the seat load detected by the load sensor, and performs occupant sensing based on the seat load after the adjustment by the adjustment value (for example, refer to JP 2004-125595A (Reference 1). In other words, in a value of the seat load detected by the load sensor, unevenness is present due to manufacturing and assembling errors of the load sensor and the seat. However, by performing a so-called “zero point correction” by the above-described configuration, it is possible to solve such a problem. In addition, accordingly, it is possible to enhance accuracy of the occupant sensing.

However, there is a possibility that the load sensor or a control device which configures the occupant sensing device is exchanged by component exchange from a state of the moment (when shipping) when the adjustment value of the seat load is set. In addition, in the above-described technology, in this case, as the zero point correction of the seat load by the adjustment value held in advance is not appropriately performed, there is a concern that accurate occupant sensing cannot be performed. Therefore, in this point, a possibility of further improvement remains.

### SUMMARY

Thus, a need exists for an occupant sensing device which is not suspectable to the drawback mentioned above.

In an occupant sensing device according to an aspect of this disclosure, it is preferable that the occupant sensing device includes: an adjustment value holding portion which holds an adjustment value of a seat load detected by a load sensor; an occupant sensing portion which senses a sitting state of an occupant in a seat provided with the load sensor based on the seat load after adjustment by the adjustment value held by the adjustment value holding portion; an identification information holding portion which holds identification information which is essential for a normal load sensor as held identification information; an identification information obtaining portion which obtains the identification information which is essential for the load sensor provided in the seat as target identification information; and a collation judgment portion which collates the held identification information held by the identification information holding portion and the target identification information obtained by the identification information obtaining portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view of an occupant sensing device;

FIG. 2 is a flowchart illustrating a processing order of occupant sensing based on a seat load after adjustment by an adjustment value;

FIG. 3 is a flowchart illustrating a processing order of setting confirmation of the adjustment value;

FIG. 4 is a flowchart illustrating a processing order of adjustment value setting;

FIG. 5 is a schematic configuration view of an occupant sensing device in a second embodiment;

FIG. 6 is a flowchart illustrating a processing order of setting confirmation of an adjustment value in the second embodiment;

FIG. 7 is a flowchart illustrating a processing order of adjustment value setting in the second embodiment; and

FIG. 8 is a flowchart illustrating determination of provisional permission of occupant sensing and a processing order thereof.

### DETAILED DESCRIPTION

### First Embodiment

Hereinafter, a first embodiment related to a vehicular occupant sensing device will be described with reference to the drawings.

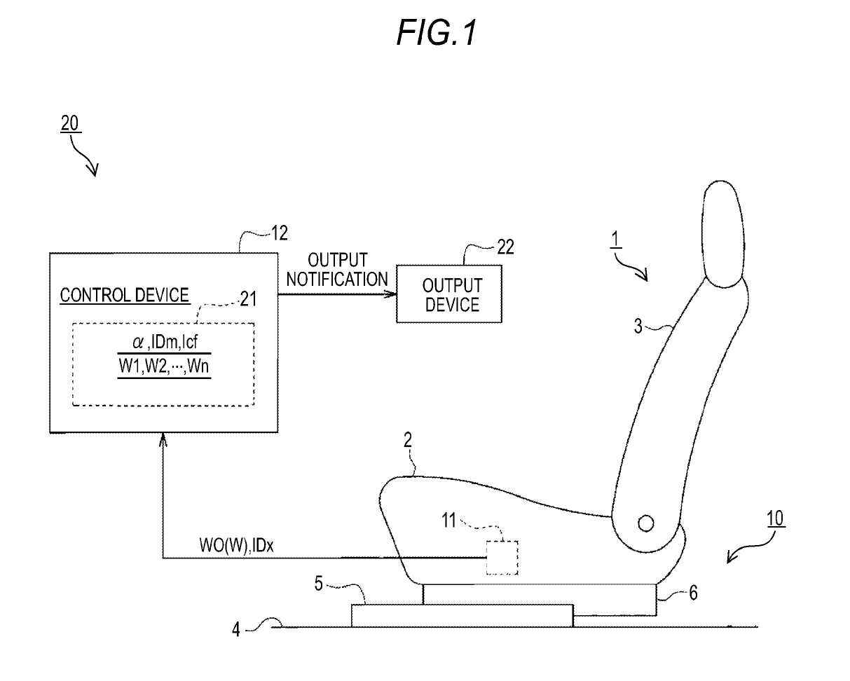

As illustrated in FIG. 1, a vehicular seat 1 includes a seat cushion 2, and a seat back 3 provided to be freely inclined with respect to a rear end portion of the seat cushion 2. In the embodiment, one pair of left and right lower rails 5 which extend in a forward-and-backward direction of a vehicle is provided on a floor portion 4 of the vehicle. In addition, an upper rail 6 which can relatively move on the lower rails 5 along an extending direction is mounted on each of the lower rails 5. In addition, the seat 1 of the embodiment is supported by an upper part of a seat slide device 10 which is formed by each of the lower rails 5 and upper rail 6.

In addition, a load sensor 11 is provided below the seat 1. In the embodiment, the load sensor 11 is provided between the upper rail 6 which configures the seat slide device 10 and the seat 1 which is supported by the upper part of the upper rail 6, as described above. In addition, the load sensor 11 of the embodiment has a known configuration in which a distortion sensor is used. Furthermore, an output signal of the load sensor 11 is input to a control device 12. In addition, in the embodiment, accordingly, an occupant sensing device 20 which senses a sitting state of an occupant in the seat 1, based on a seat load (W) detected by the load sensor 11, is formed.

Specifically, the control device 12 of the embodiment holds an adjustment value α of a seat load W0 detected as the output signal of the load sensor 11 in a storage region (memory) 21. In other words, the control device 12 of the embodiment performs a so-called zero point correction in which the adjustment value α is used. In addition, it is configured that occupant sensing is performed based on the seat load W after adjustment by the adjustment value α.

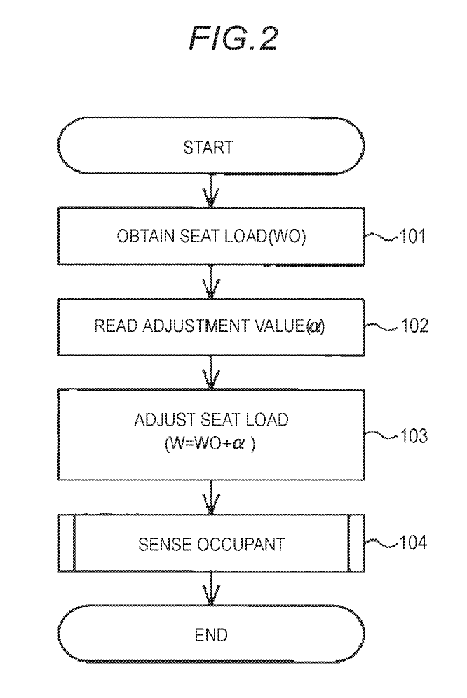

Specifically, as illustrated in a flowchart of FIG. 2, if the control device 12 of the embodiment obtains the seat load W0 from the load sensor 11 (step 101), and then, the control device 12 reads the adjustment value α from the storage region 21 (step 102). In addition, by adding the adjustment value α to the seat load W0, the seat load W0 is adjusted (step 103, W=W0+α).

In addition, the control device 12 of the embodiment holds a plurality of threshold values in the storage region 21 (refer to FIG. 1, W1, W2, . . . , Wn). In addition, it is configured to sense the sitting state (for example, whether the occupant is an adult or a child, a man or a woman, or a person or luggage) of the occupant in the seat 1 as the seat load W adjusted in the above-described step 103 is compared to each threshold value (step 104).

As illustrated in FIG. 1, the control device 12 of the embodiment performs a command of outputting a notification for prompting the occupant sitting in the seat 1 to wear a seat belt, or a command of changing a mode of an airbag expansion control. Furthermore, in the embodiment, the notification output by the control device 12 is performed via an output device 22 provided in a vehicle, such as a warning lamp or a speaker (not illustrated) provided on an instrument panel of the vehicle. Accordingly, the sense of sight and the sense of hearing of the occupant prompts a factor of generating notification output to be corrected.

Setting Confirmation Function of Adjustment Value

Next, a setting confirmation function of the adjustment value α which is mounted in the occupant sensing device 20 of the embodiment will be described.

As illustrated in FIG. 1, the control device 12 of the embodiment holds the adjustment value α and identification information which is essential for the load sensor 11, as held identification information IDm, with respect to the normal load sensor 11 which holds the adjustment value α of the seat load W0 in the storage region 21 as described above. In addition, the control device 12 obtains the identification information which is essential for the load sensor 11 which is currently provided in the seat 1 as target identification information IDx. Furthermore, in the embodiment, a serial number which is given to the load sensor 11 in advance is used as the identification information which is essential for the load sensor 11. Furthermore, the control device 12 holds set information Icf regarding whether or not the adjustment value α held is set by normal setting processing performed by the control device 12, in the storage region 21. In addition, the control device 12 of the embodiment is configured to perform the setting confirmation of the adjustment value α based on various pieces of information (IDm, IDx, Icf).

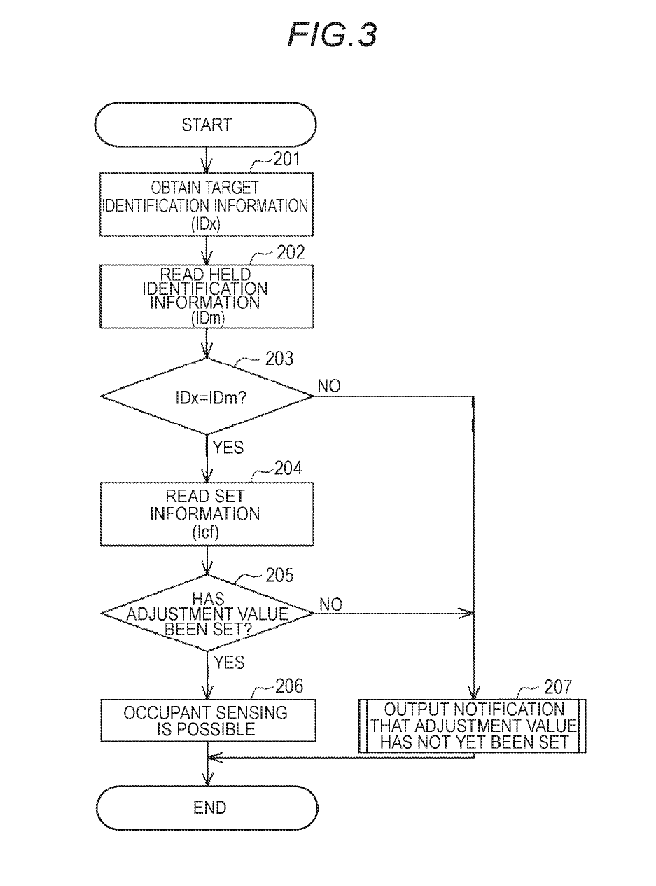

Specifically, as illustrated in a flowchart of FIG. 3, the control device 12 of the embodiment, first, obtains the target identification information IDx of the load sensor 11 which is currently provided in the seat 1 (step 201). Then, the control device 12 reads the held identification information IDm which is related to the normal load sensor 11 from the storage region 21 (step 202). In addition, the control device 12 collates the held identification information IDm held by the storage region 21, and the target identification information IDx obtained from the load sensor 11 (step 203).

Next, in the above-described step 203, when it is judged that the held identification information IDm and the target identification information IDx match each other (step 203: YES), the control device 12 reads the set information Icf from the storage region 21 (step 204), and it is judged whether or not the set information Icf illustrates that “the adjustment value α has already been set” (step 205). In addition, when the set information Icf illustrates that “the adjustment value α has already been set” (step 205: YES), the control device 12 of the embodiment determines that it is possible to perform the occupant sensing based on the seat load W after the adjustment by the adjustment value α (step 206).

In addition, when the set information Icf illustrates that “the adjustment value α has not yet been set” in the above-described step 205 (step 205: NO), the control device 12 of the embodiment outputs a notification that “the adjustment value α has not yet been set” via the output device 22 (step 207). In addition, in the above-described step 203, even when it is judged that the held identification information IDm and the target identification information IDx do not match each other (step 203: NO), the notification that the adjustment value α has not yet been set is output in the above-described step 207.

In other words, a case where the held identification information IDm and the target identification information IDx do not match each other illustrates a case where the load sensor 11 which is currently provided in the seat 1 is not the normal load sensor 11 in which the adjustment value α is held by the storage region 21 of the control device 12, that is, a case where the load sensor 11 or the control device 12 is exchanged, when viewed from the control device 12 side. In this case, there is a high possibility that the adjustment value α held by the storage region 21 of the control device 12 is not appropriate.

In consideration of this, the control device 12 of the embodiment performs the occupant sensing (refer to FIG. 2) in which the seat load W after adjustment is used by the adjustment value α only in a case where the set information Icf illustrates that “has already been set”. In addition, even when the held identification information IDm and the target identification information IDx do not match each other, the notification that the adjustment value α has not yet been set is output. Accordingly, the occupant sensing device 20 of the embodiment is configured to perform more accurate occupant sensing by prompting correct setting of the adjustment value α of the seat load W0.

Next, processing of setting the adjustment value α in the occupant sensing device 20 of the embodiment will be described.

In the occupant sensing device 20 of the embodiment, when the notification that the adjustment value has not yet been set is output as described above (refer to FIG. 3, step 207), the control device 12 is configured to start the setting processing regarding the adjustment value α of the seat load W0 held by the storage region 21 as an operator performs a predetermined operation.

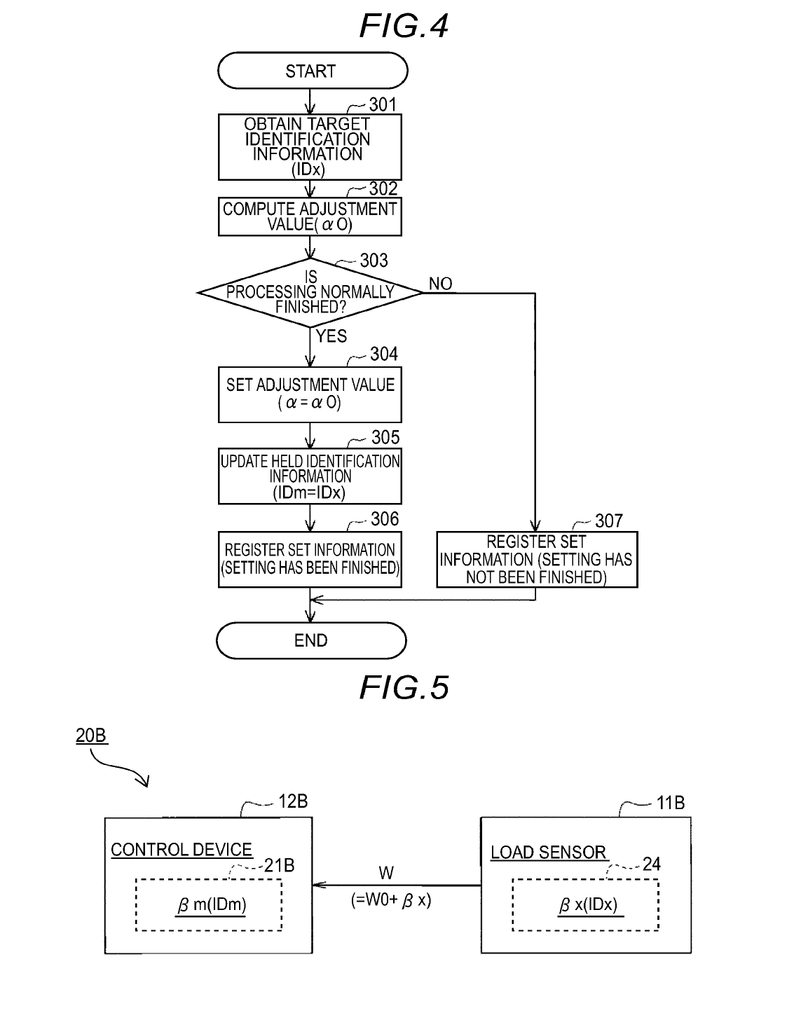

Specifically, as illustrated in the flowchart of FIG. 4, in the adjustment value setting processing, first, the control device 12 of the embodiment obtains a serial number which becomes the target identification information IDx from the load sensor 11 which is currently provided in the seat 1, as a target to be set from the adjustment value α of the seat load W0 (step 301). In addition, the control device 12 computes an adjustment value α0 of the seat load W0, based on a known computing method which is used in a case where the zero point correction is associated with unevenness which is a factor of manufacturing and assembling errors of the load sensor 11 or the seat 1 is performed (step 302).

Next, the control device 12 of embodiment judges whether or not the adjustment value computing processing is correctly performed in step 302 (step 303). Furthermore, the control device 12 of the embodiment is configured so that the adjustment value computing processing is abnormally finished in step 302, for example, when time is expired due to a reason that a value of the seat load W0 detected by the load sensor 11 is not stable. In addition, in step 303, when it is judged that the adjustment value computing processing is correctly performed (step 303: YES, the processing is finished normally), the control device 12 of the embodiment writes the adjustment value α0 computed in step 302 in the storage region 21. In other words, by updating the adjustment value α held by the storage region 21 to the adjustment value α0 which is newly computed (α=α0), the adjustment value α is set (step 304).

Next, the control device 12 of the embodiment updates the held identification information IDm held by the storage region 21 to the target identification information IDx obtained in the above-described step 301 (step 305). Furthermore, the control device 12 registers the set information Icf illustrating that “the adjustment value α has been set” to the storage region 21 (step 306). Accordingly, when performing the next setting confirmation processing, the occupant sensing device 20 of the embodiment determines that the control device 12 can perform the occupant sensing based on the seat load W after adjustment by the adjustment value α (refer to FIG. 3, step 206).

Furthermore, when it is judged that the adjustment value computing processing is abnormally finished in step 302 in the above-described step 303 (step 303: NO), the control device 12 registers the set information Icf illustrating that “the adjustment value α has not yet been set” to the storage region 21 without performing the processing of the above-described step 304 and step 305 (step 307). Accordingly, when performing the next setting confirmation processing, the occupant sensing device 20 of the embodiment repeatedly prompts the control device 12 to set the correct adjustment value α by outputting the notification that the adjustment value has not yet been set, again (refer to FIG. 3, step 207).

Above, according to the embodiment, it is possible to achieve the following effects.

(1) The control device 12 which configures the occupant sensing device 20 together with the load sensor 11 provided in the seat 1 holds the identification information which is essential for the normal load sensor 11 as the held identification information IDm to the storage region 21. In addition, the control device 12 obtains the identification information which is essential for the load sensor 11 which is currently provided in the seat 1 as the target identification information IDx. Furthermore, the control device 12 collates the held identification information Im held by the storage region 21 and the target identification information IDx obtained from the load sensor 11 which is a target to be confirmed. In addition, when it is judged that the held identification information IDm and the target identification information IDx do not match each other, the control device 12 outputs the notification that the adjustment value cc of the seat load W0 has not yet been set.

According to the above-described configuration, it is possible to confirm whether or not the load sensor 11 which is currently provided in the seat 1 is the same as the normal load sensor 11 which corresponds to the adjustment value α set in advance, that is, whether or not the adjustment value α held by the storage region 21 of the control device 12 is appropriate. Accordingly, it is possible to determine whether or not the occupant sensing based on the load sensor 11 is performed. In addition, when it is judged that the held identification information IDm and the target identification information IDx do not match each other, as the notification that the adjustment value α of the seat load W0 has not yet been set is informed, it is possible to prompt the setting of new adjustment value α. As a result, even when the load sensor 11 or the control device 12 which is provided in the seat 1 is exchanged by the component exchange, it is possible to correctly set the adjustment value α of the seat load W0, and to perform accurate occupant sensing.

(2) The control device 12 computes the adjustment value α of the seat load W0 detected by the load sensor 11 which is currently provided in the seat 1. In addition, the control device 12 writes the computed adjustment value α to the storage region 21. In other words, by updating the adjustment value α held by the storage region 21 to the adjustment value α0 which is newly computed (α=α0), the adjustment value α is set. In addition, when setting the adjustment value α, the control device 12 updates the held identification information IDm held by the storage region 21 to the target identification information IDx obtained from the load sensor 11 provided in the seat 1.

According to the above-described configuration, even when the load sensor 11 or the control device 12 which is provided in the seat 1 is exchanged by the component exchange, it is possible to correctly set the adjustment value α of the seat load W0, and to register the load sensor 11 in which the adjustment value α is set, as the “normal load sensor”. Accordingly, it is possible to perform accurate occupant sensing.

(3) The control device 12 holds the set information Icf regarding whether or not the adjustment value α held is set by the normal setting processing performed by the control device 12, in the storage region 21. In addition, when the normal setting processing is not performed, the notification that the adjustment value α has not yet been set is output via the output device 22. Accordingly, it is possible to prevent settings from being forgotten by prompting the setting of the adjustment value α when performing initial setting.

### Second Embodiment

Hereinafter, a second embodiment related to a vehicular occupant sensing device will be described with reference to the drawings. Furthermore, for convenience of the description, configuration elements similar to those in the above-described first embodiment are given the same reference numerals, and the description thereof will be omitted.

As illustrated in FIG. 5, a memory 24 which is a storage region in a load sensor 11B is provided in an occupant sensing device 20B of the embodiment. In addition, an adjustment value βx of the seat load W0 detected by the load sensor 11 is held by the memory 24. In addition, in the embodiment, on the load sensor 11B side, the adjustment of the seat load W0 (W=W0+βx) in which the adjustment value βx is used is performed.

In other words, the seat load W after adjustment is input by the adjustment value βx to a control device 12B of the embodiment. In addition, the control device 12B of the embodiment performs the occupant sensing based on the seat load W after adjustment which is input from the load sensor 11B.

In addition, the control device 12B of the embodiment holds a value (adjustment value βm) which is equivalent to the adjustment value βm held by the memory 24 of the normal load sensor 11B provided in the seat 1, in a storage region 21B. In addition, the control device 12B obtains the adjustment value βx held by the memory 24 of the load sensor 11B currently provided in the seat 1 as the target identification information IDx. In addition, the control device 12B of the embodiment collates and judges whether or not the load sensor 11B which is currently provided in the seat 1, and the normal load sensor 11B which holds the adjustment value βm in the storage region 21B are the same as each other, by considering the adjustment value βm held by the storage region 21B as the held identification information IDm.

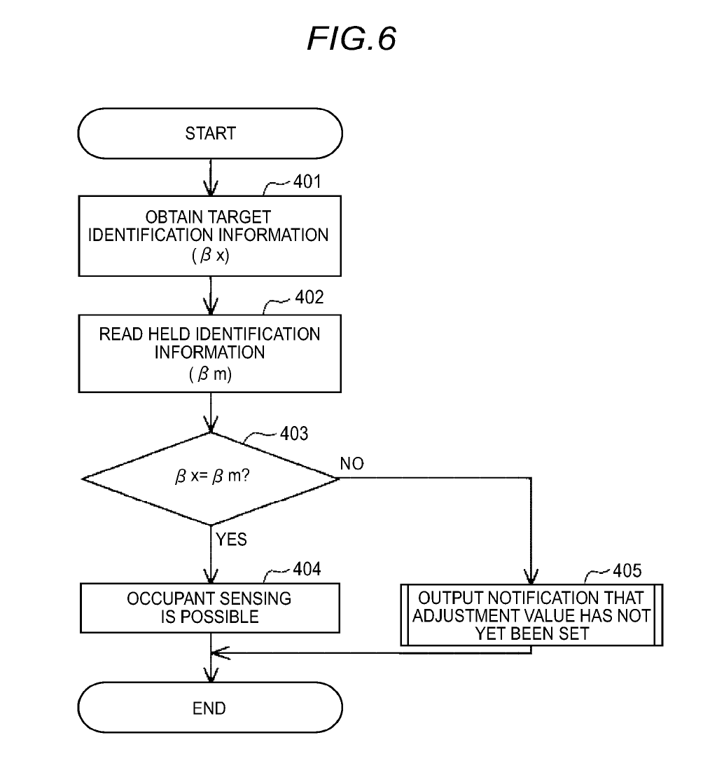

Specifically, as illustrated in a flowchart of FIG. 6, first, the control device 12B of the embodiment obtains the adjustment value βx of the seat load W0 held by the memory 24 of the load sensor 11B which is currently provided in the seat 1 as the target identification information IDx (step 401). In addition, the control device 12B reads the adjustment value βm which is held as the held identification information IDm related to the normal load sensor 11, from the storage region 21B (step 402). Next, the control device 12B collates the adjustment value βm read from the storage region 21B as the held identification information IDm and the adjustment value βx obtained from the load sensor 11B as the target identification information IDx (step 403). In addition, when it is judged that the adjustment value βm held by the storage region 21B and the adjustment value βx obtained from the load sensor 11B match each other (step 403: YES, βx=βm), it is configured to determine that the occupant sensing can be performed based on the seat load W after adjustment input from the load sensor 11B (step 404).

In other words, when the adjustment value βm held as the held identification information IDm and the adjustment value βx obtained as the target identification information IDx match each other, it is possible to determine that “the adjustment value βx has already been set”. In addition, when the adjustment value βm held as the held identification information IDm and the adjustment value βx obtained as the target identification information IDx do not match each other in the above-described step 403 (step 403: NO), the control device 12B of the embodiment outputs the notification that the “adjustment value βx has not yet been set” via the output device 22 (step 405).

Furthermore, in the occupant sensing device 20 of the embodiment, when the notification that the adjustment value has not yet been set is output, the setting processing regarding the adjustment value βx held by the memory 24 of the load sensor 11B is also started as the operator performs a predetermined operation.

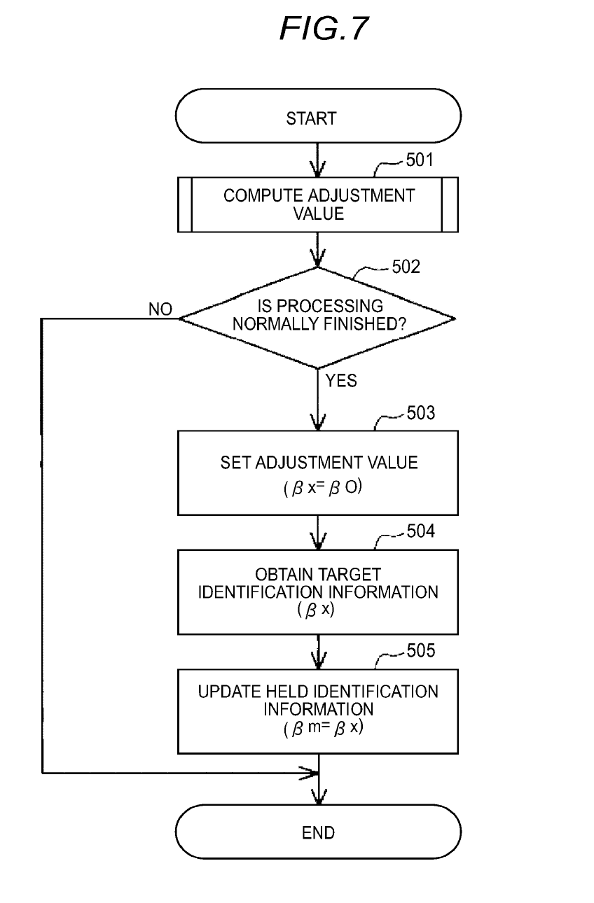

Specifically, as illustrated in the flowchart of FIG. 7, when computing an adjustment value β0 in the load sensor 11B provided in the seat 1 (step 501), then, the control device 12B of the embodiment judges whether or not the adjustment value computing processing is correctly performed in step 501 (step 502). In addition, in step 502, when it is judged that the adjustment value computing processing is correctly performed (step 502: YES, the processing is normally finished), it is indicated that the adjustment value βx computed in step 501 is written in the memory 24, with respect to the load sensor 11B. In other words, by updating the adjustment value βx held by the memory 24 to the adjustment value β0 which is newly computed (β=β0), the adjustment value βx is set (step 503).

In addition, even when the new adjustment value βx is set in the above-described step 503, the control device 12B of the embodiment obtains the adjustment value βx of the seat load W0 held by the memory 24 of the load sensor 11B provided in the seat 1 as the target identification information IDx (step 504). In addition, by writing the adjustment value βx obtained as the target identification information IDx in the storage region 21B, the adjustment value βm which serves as the held identification information IDm held by the storage region 21B is updated (step 505, βm=βx).

Above, in the occupant sensing device 20B of the embodiment, it is also possible to achieve effects similar to those of the occupant sensing device 20 in the above-described first embodiment. In other words, the adjustment value βx of the seat load W0 held by the memory 24 of the load sensor 11B can be used as the identification information which is essential for the load sensor 11B. In addition, if the adjustment value βx which serves as the target identification information IDx obtained from the load sensor 11B and the adjustment value βm which serves as the held identification information IDm held by the storage region 21B of the control device 12B, the load sensor 11 B provided in the seat 1 is the “normal load sensor”, and the adjustment value βx “has already been set”. Therefore, according to the above-described configuration, similar to the above-described first embodiment, it is possible to correctly set the adjustment value βx of the seat load WO, and to perform accurate occupant sensing.

In addition, each of the above-described embodiments may be changed as follows.

The number and the disposition of the load sensor 11 (11B) provided in the seat 1 may be arbitrary changed.

In the above-described first embodiment, as the identification information which is essential for the load sensor 11, the serial number which is given to the load sensor 11 in advance is used. In addition, in the second embodiment, the adjustment value βx of the seat load W0 held by the memory 24 of the load sensor 11B is used as the identification information which is essential for the load sensor 11B. However, not being limited thereto, any “identification information which is essential” for the load sensor 11 may be used if the identification information can be the held identification information IDm and the target identification information IDx.

In each of the above-described embodiments, when the held identification information IDm and the target identification information IDx do not match each other, the control device 12 (12B) does not perform the occupant sensing based on the seat load W after adjustment by the adjustment value α (βx). However, not being limited thereto, when the adjustment value βx held by the memory 24 of the load sensor 11B is used as the target identification information IDx of the load sensor 11, by considering the held identification information IDm held by the storage region 21B of the control device 12B as a reference, it is decided whether or not to perform the occupant sensing based on the seat load W after adjustment by the adjustment value βx.

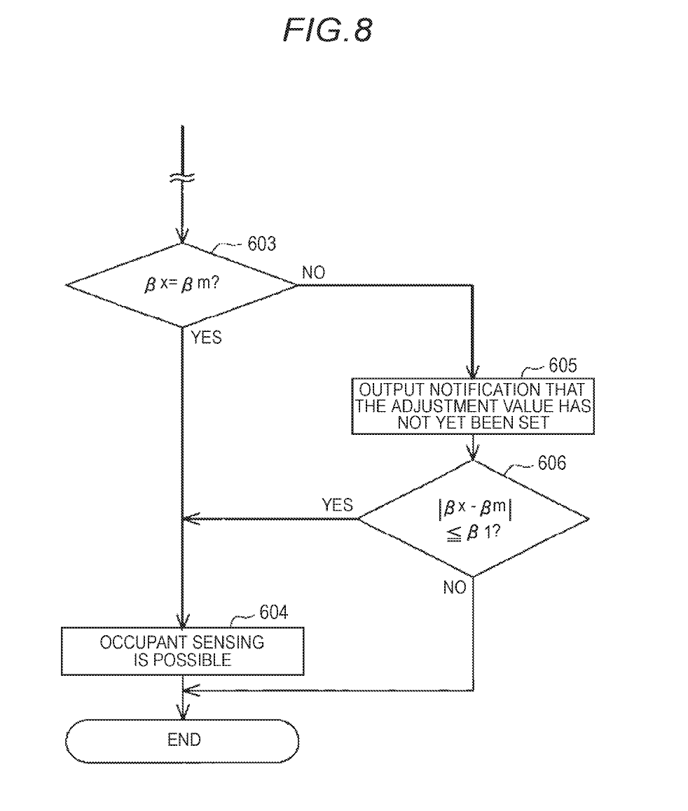

For example, as illustrated in a flowchart of FIG. 8, when it is judged that the adjustment value βm held as the held identification information IDm and the adjustment value βx obtained as the target identification information IDx do not match each other (step 603: NO), it is judged whether or not the difference value between both (absolute value thereof) is equal to or less than a predetermined threshold value β1 (step 606). Furthermore, in the flowchart of FIG. 8, each processing of step 601 to step 605 is the same as each processing of step 401 to step 405 in the flowchart of FIG. 6. In addition, when the difference value between both is equal to or less than the predetermined threshold value β1 (step 606: YES, |βx−βm|≦β1), similar to a case where the adjustment value βm held as the held identification information IDm and the adjustment value βx obtained as the target identification information IDx match each other (step 603: YES, βx=βm), it may be determined that the occupant sensing is possible.

In other words, even when the load sensor 11B which is currently provided in the seat 1 is not the same as the normal load sensor 11B in which the adjustment value βm is held by the storage region 21B of the control device 12B, if the value of the adjustment value βx held by the memory 24 of the load sensor 11B is appropriate, there is no problem. Therefore, according to the above-described configuration, during the time when new load sensor 11B is set, it is possible to provisionally perform the occupant sensing.

In the above-described first embodiment, when it is judged that the held identification information IDm and the target identification information IDx match each other (step 203: YES), it is judged whether or not the set information Icf illustrates that “the adjustment value α has already been set” (step 205). However, not being limited thereto, the judgment on whether or not the adjustment value α has been set in advance may be performed from the judgment on whether or not the held identification information IDm and the target identification information IDx match each other. In addition, the judgment on whether or not the adjustment value α has been set may not be performed.

Furthermore, being separated from the held identification information IDm (for example, the serial number), the control device 12B holds the adjustment value βm which corresponds to the normal load sensor 11B by the storage region 21B. In addition, when the held identification information IDm and the target identification information IDx match each other, it may be configured to judge whether or not the adjustment value βm held by the storage region 21B of the control device 12B and the adjustment value βx held by the memory 24 of the load sensor 11B match each other. In this configuration, even when the seat load W output by the load sensor 11B due to abnormality of the load sensor 11B changes, it is possible to rapidly sense generation of abnormality.

In the occupant sensing device 20 of the above-described first embodiment, the control device 12 (and the storage region 21) is configured of an adjustment value holding portion, an occupant sensing portion, an identification information holding portion, an identification information obtaining portion, a collation judgment portion, an adjustment value computing portion, an adjustment value setting portion, an identification information update portion, a set information holding portion, an informing portion, and a mismatch informing portion. However, not being limited thereto, each functional configuration portion may be formed in a form of being dispersed in a plurality of control devices. In addition, similar to the occupant sensing device 20B in the above-described second embodiment, regarding a case where the memory 24 of the load sensor 11 configures the adjustment value holding portion, each function configuration portion other than the adjustment value holding portion may be provided in a form of being dispersed to the control device in addition to the load sensor 11.

In each of the above-described embodiments, when it is judged that the adjustment value (α, βx) of the seat load W0 is not set by the normal setting processing, the setting processing of the adjustment value (α, βx) is started as the operator performs a predetermined operation after outputting the notification related thereto. However, not being limited thereto, after outputting the notification that the adjustment value has not yet been set, immediately, the setting processing of the adjustment value (α, βx) may be started. In addition, as the setting processing of the adjustment value (α, βx) is started, the notification that the adjustment value has not yet been set may also be output.

Next, a technical concept which can be ascertained from the above-described embodiments will be described together with the effects.

In an occupant sensing device according to an aspect of this disclosure, it is preferable that the occupant sensing device includes: an adjustment value holding portion which holds an adjustment value of a seat load detected by a load sensor; an occupant sensing portion which senses a sitting state of an occupant in a seat provided with the load sensor based on the seat load after adjustment by the adjustment value held by the adjustment value holding portion; an identification information holding portion which holds identification information which is essential for a normal load sensor as held identification information; an identification information obtaining portion which obtains the identification information which is essential for the load sensor provided in the seat as target identification information; and a collation judgment portion which collates the held identification information held by the identification information holding portion and the target identification information obtained by the identification information obtaining portion.

According to this configuration, it is possible to confirm whether or not the load sensor which is currently provided in the seat is the same as a normal load sensor which corresponds to the adjustment value set in advance, that is, whether or not the adjustment value held by the adjustment value holding portion is appropriate. In addition, accordingly, it is possible to determine whether or not to perform the occupant sensing based on the load sensor, and to prompt the setting of new adjustment value. As a result, even when the load sensor provided in the seat or the control device which performs the occupant sensing is exchanged by component exchange, it is possible to correctly set the adjustment value of the seat load, and to perform accurate occupant sensing.

In the occupant sensing device according to the aspect of this disclosure, it is preferable that the occupant sensing device further includes an adjustment value computing portion which computes the adjustment value of the load sensor provided in the seat; an adjustment value setting portion which sets the adjustment value computed by the adjustment value computing portion to the adjustment value held by the adjustment value holding portion; and an identification information update portion which updates the held identification information to the target identification information in a case where the adjustment value setting portion sets the adjustment value.

According to this configuration, even when the load sensor provided in the seat or the control device which performs the occupant sensing is exchanged by the component exchange, it is possible to correctly set the adjustment value of the seat load, and to register the load sensor in which the setting of the adjustment value is performed as a “normal load sensor”. In addition, accordingly, it is possible to perform accurate occupant sensing.

In the occupant sensing device according to the aspect of this disclosure, it is preferable that the occupant sensing device further includes a set information holding portion which holds set information regarding whether or not the adjustment value is in a state of being set by the adjustment value setting portion; and an informing portion which informs a notification that the adjustment value has not yet been set, in a case where the setting of the adjustment value is not performed by the adjustment value setting portion.

According to this configuration, it is possible to prevent setting from being forgotten by prompting the setting of the adjustment value when performing initial setting.

In the occupant sensing device according to the aspect of this disclosure, it is preferable that the occupant sensing device further includes a mismatch informing portion which informs a notification that the adjustment value has not yet been set, in a case where the target identification information and the held identification information do not match each other.

That is, when viewed from the control device side, a case where the held identification information and the target identification information do not match each other illustrates a case where the load sensor which is currently provided in the seat is not the normal load sensor, that is, a load sensor or a control device is exchanged. In this case, there is a high possibility that the adjustment value held by the adjustment value holding portion is not appropriate. Therefore, in the above-described configuration, it is possible to perform accurate occupant sensing by actively prompting the setting of the adjustment value.

In the occupant sensing device according to the aspect of this disclosure, it is preferable that the occupant sensing device further includes the load sensor which includes the adjustment value holding portion and outputs the seat load after adjustment by the adjustment value; and a control device which includes the occupant sensing portion, the identification information holding portion, the identification information obtaining portion, and the collation judgment portion, in which the adjustment value is used as identification information which is essential for the load sensor.

That is, if the adjustment value which serves as the target identification information obtained from the identification information holding portion on the load sensor side, and the adjustment value which serves as the held identification information which is held by the identification information holding portion on the control device side do not match each other, the load sensor provided in the seat is the “normal load sensor”, and the adjustment value has already been “set” correctly. Therefore, according to the above-described configuration, it is possible to correctly set the adjustment value of the seat load, and to perform accurate occupant sensing.

In the occupant sensing device according to the aspect of this disclosure, it is preferable that, the control device includes a provisional permission portion which permits the occupant sensing based on the seat load after the adjustment which is output by the load sensor in a case where a difference value between the adjustment value held by the identification information holding portion as the held identification information and the adjustment value obtained from the adjustment value holding portion of the load sensor as the target identification information is equal to or less than the predetermined threshold value. Accordingly, during the time when new load sensor is set, it is possible to provisionally perform the occupant sensing.

According to the aspects of this disclosure, it is possible to correctly set the adjustment value of the seat load, and to perform accurate occupant sensing.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An occupant sensing device comprising:
an adjustment value holding portion which holds an adjustment value of a seat load detected by a load sensor;
an occupant sensing portion which senses a sitting state of an occupant in a seat provided with the load sensor based on the seat load after adjustment by the adjustment value held by the adjustment value holding portion;
an identification information holding portion which holds identification information which is essential for a normal load sensor as held identification information;
an identification information obtaining portion which obtains the identification information which is essential for the load sensor provided in the seat as target identification information; and
a collation judgment portion which collates the held identification information held by the identification information holding portion and the target identification information obtained by the identification information obtaining portion.

2. The occupant sensing device according to claim 1, further comprising:
an adjustment value computing portion which computes the adjustment value of the load sensor provided in the seat;
an adjustment value setting portion which sets the adjustment value computed by the adjustment value computing portion to the adjustment value held by the adjustment value holding portion; and
an identification information update portion which updates the held identification information to the target identification information in a case where the adjustment value setting portion sets the adjustment value.

3. The occupant sensing device according to claim 2, further comprising:
a set information holding portion which holds set information regarding whether or not the adjustment value is in a state of being set by the adjustment value setting portion; and
an informing portion which informs a notification that the adjustment value has not yet been set in a case where the setting of the adjustment value is not performed by the adjustment value setting portion.

4. The occupant sensing device according to claim 1, further comprising:
a mismatch informing portion which informs a notification that the adjustment value has not yet been set in a case where the target identification information and the held identification information do not match each other.

5. The occupant sensing device according to claim 2, further comprising:
a mismatch informing portion which informs a notification that the adjustment value has not yet been set in a case where the target identification information and the held identification information do not match each other.

6. The occupant sensing device according to claim 3, further comprising:
a mismatch informing portion which informs a notification that the adjustment value has not yet been set in a case where the target identification information and the held identification information do not match each other.

7. The occupant sensing device according to claim 1, further comprising:
the load sensor which includes the adjustment value holding portion and outputs the seat load after adjustment by the adjustment value; and
a control device which includes the occupant sensing portion, the identification information holding portion, the identification information obtaining portion, and the collation judgment portion,
wherein the adjustment value is used as identification information which is essential for the load sensor.

8. The occupant sensing device according to claim 2, further comprising:
the load sensor which includes the adjustment value holding portion and outputs the seat load after adjustment by the adjustment value; and
a control device which includes the occupant sensing portion, the identification information holding portion, the identification information obtaining portion, and the collation judgment portion,
wherein the adjustment value is used as identification information which is essential for the load sensor.

9. The occupant sensing device according to claim 3, further comprising:
the load sensor which includes the adjustment value holding portion and outputs the seat load after adjustment by the adjustment value; and
a control device which includes the occupant sensing portion, the identification information holding portion, the identification information obtaining portion, and the collation judgment portion,
wherein the adjustment value is used as identification information which is essential for the load sensor.

10. The occupant sensing device according to claim 4, further comprising:
the load sensor which includes the adjustment value holding portion and outputs the seat load after adjustment by the adjustment value; and
a control device which includes the occupant sensing portion, the identification information holding portion, the identification information obtaining portion, and the collation judgment portion,
wherein the adjustment value is used as identification information which is essential for the load sensor.

11. The occupant sensing device according to claim 7,
wherein the occupant sensing is permitted in a case where a difference value between the adjustment value held by the identification information holding portion as the held identification information, and the adjustment value obtained from the adjustment value holding portion of the load sensor as the target identification information is equal to or less than a predetermined threshold value.

12. The occupant sensing device according to claim 8,
wherein the occupant sensing is permitted in a case where a difference value between the adjustment value held by the identification information holding portion as the held identification information, and the adjustment value obtained from the adjustment value holding portion of the load sensor as the target identification information is equal to or less than a predetermined threshold value.

13. The occupant sensing device according to claim 9,
wherein the occupant sensing is permitted in a case where a difference value between the adjustment value held by the identification information holding portion as the held identification information, and the adjustment value obtained from the adjustment value holding portion of the load sensor as the target identification information is equal to or less than a predetermined threshold value.

14. The occupant sensing device according to claim 10,
wherein the occupant sensing is permitted in a case where a difference value between the adjustment value held by the identification information holding portion as the held identification information, and the adjustment value obtained from the adjustment value holding portion of the load sensor as the target identification information is equal to or less than a predetermined threshold value.
